(19) United States
(12) Patent Application Publication
(10) Pub. No.: US 2012/0170462 A1
(43) Pub. Date: Jul. 5, 2012

(54) TRAFFIC FLOW CONTROL BASED ON VLAN AND PRIORITY

(75) Inventor: Abhishek Sinha, Woodland Hills, CA (US)

(73) Assignee: Alcatel Lucent USA Inc.

(21) Appl. No.: 12/984,666

(22) Filed: Jan. 5, 2011

(51) Int. Cl. H04L 12/24

(52) U.S. Cl. 370/236

(57) ABSTRACT

A method for controlling traffic flow at a traffic routing device of a network comprises a plurality of operations. An operation is performed for determining an instance of traffic flow congestion for traffic of a particular VLAN (virtual local area network) flow control group and having a particular priority. The particular VLAN flow control group and the particular priority jointly define a particular prioritized VLAN flow control group. An operation is performed for issuing traffic flow instructions for causing flow of the traffic of the particular prioritized VLAN flow control group to be temporarily inhibited. Thereafter, an operation is performed for inhibiting transmission of traffic for the particular prioritized VLAN flow control group at a particular traffic routing device in response to the particular traffic routing device receiving the traffic flow instructions.

### FIELD OF THE DISCLOSURE

The disclosures made herein relate generally to flow control mechanisms in network systems and, more particularly, to implementing flow control based on a combination of VLAN group information and priority information.

### BACKGROUND

One known mechanism for implementing flow control in an Ethernet network (i.e., a network system) utilizes per-port flow control to support lossless traffic management. When congestion in the network occurs, an overwhelmed upstream switch notifies ports of downstream switches (i.e., transmitting devices) to stop transmission of traffic for a specified period of time (e.g., via a pause control frame). A significant disadvantage of this per-port flow control mechanism is that it acts on a per-port basis and, thus, the transmitting devices (e.g., an aggregation switch) stops all the traffic out of the port corresponding to the congested traffic. Stopping all traffic in such a per-port manner has the potential to adversely impact all traffic flows out of that port regardless whether they are contributing to the congestion or not.

An example of implementing traffic flow control on a per-port basis is shown in FIGS. 1A and 1B. A source of congestion (i.e., a first traffic source 100A) exists behind an aggregation switch 105 between a first downstream switch 110A and the first traffic source 100A, as shown in FIG. 1A. Traffic that is causing such congestion (e.g., DS(110A): VLAN 10) from the first traffic source 100A is provided through a particular port of the aggregation switch 105. The result of this source of congestion is congestion at the core switch 115, which is connected to a plurality of upstream switches (e.g., first upstream switch 120A and second upstream switch 120B). Certain traffic on the same particular port of the aggregation switch 105 from other traffic sources connected to the first downstream switch 110A (e.g., DS(110A): VLAN 20) and certain traffic from other downstream switches connected to the aggregation switch 105 (e.g., DS(110B): VLAN 30, VLAN 40) are not contributing to such congestion. As shown in FIG. 1B, in response to a flow control message (e.g., pause frames on the particular port) being sent from the core switch 115 to the aggregation switch 105, traffic flows through the particular port of the aggregation switch 105 from all of downstream switches connected to it is affected (i.e., traffic flows on the particular port are stopped at the respective downstream switch).

Another known mechanism for implementing flow control utilizes priority to support lossless traffic management. For example, this type of priority-based flow control mechanism has been proposed in IEEE (Institute of Electrical and Electronic Engineers) 802.3 standard. When congestion in the network occurs, the overwhelmed switch transmits a pause control frame to the downstream link identifying the priority of the traffic that is leading to congestion (i.e., affected priority traffic). In this manner, the overwhelmed switch notifies ports of downstream link to stop transmission of affected priority traffic for a specified period of time. This ensures that the traffic of unaffected priority does not get stalled in case of congestion on some other priority. This flow control mechanism alleviates the problem(s) of per-port flow control to some extent.

However, such a priority-based flow control mechanism does not address problem arising from when multiple flows across a switch are operating at the same priority. In case of aggregation and core networks, switches would be aggregating multiple traffic flows encapsulated in multiple VLANs (virtual local area networks) on the network links. All these traffic flows could be carrying traffic for multiple VLANs at the same priority level. In case of congestion, these switches (i.e., network devices) would throttle traffic for all the VLAN traffic on the same priority regardless of whether they are contributing to congestion or not. This has substantial adverse impact on network performance and leads to under utilization on network data paths that are not contributing to congestion, but that still suffer (e.g., are throttled) because of adverse traffic flow considerations associated with traffic of a different priority.

An example of implementing traffic flow control on a per-priority basis is shown in FIGS. 2A and 2B. A source of congestion (i.e., a first traffic source 200A) exists behind an aggregation switch 205 between a first downstream switch 210A and the first traffic source 200A, as shown in FIG. 2A. Traffic that is causing such congestion (e.g., DS(210A): P(2): VLAN 10, VLAN 20) has a particular priority. The result of this source of congestion is congestion at the core switch 215, which is connected to a plurality of upstream switches (e.g., first upstream switch 220A and second upstream switch 220B). Certain other traffic that traverses the aggregation switch 205 toward the core switch 215has the same priority as the offending traffic (e.g., traffic of priority (P(2)) from second downstream switch 210B), but is not contributing to such congestion. As shown in FIG. 2B, in response to a flow control message (e.g., pause frames on a particular port for Priority (P(2))) being sent from the core switch 215 to the aggregation switch 205, the aggregation switch 205 throttles traffic on itself for all of its VLANs sending traffic under the priority 2 (P(2)). Undesirably, as also shown in FIG. 2B, traffic associated with the second downstream switch 210B, which was not contributing to the congestion, but that is of the same priority (i.e., congestion priority 2), is also throttled by the aggregation switch 205.

Therefore, a flow control mechanism that overcomes drawbacks associated with known flow control mechanisms (e.g., per-port flow control, priority-based flow control, etc) would be useful, advantageous and novel.

### SUMMARY OF THE DISCLOSURE

Flow control mechanisms configured in accordance with embodiments of the present invention provide for traffic flow control dependent upon a combination of VLAN group and priority. Flow control based on VLAN group and priority provides for the application of flow control on Ethernet packets belonging to a VLAN group and having a specific traffic priority assigned to it. In accordance with the present invention, a group of VLANs with same network behavior (e.g., network topology path/QOS (quality of service) behavior) can be bunched (i.e., aggregated together to be considered as part of the same “VLAN flow control group”. Whatever flow control behavior is applied on one member VLAN is applicable for the entire group. In this manner, the action is applicable on the aggregated group of VLANs. Such a subset of VLANs is referred to herein as a “VLAN flow control group”. Accordingly, traffic segregated on a per-priority basis within a per-VLAN flow control group is defined herein as a “prioritized VLAN flow control group”.

A VLAN flow control group configured in accordance with the present invention advantageously aids in isolating a congestion state in a network to only the set of associated VLANs (i.e., a particular prioritized VLAN flow control group) without affecting other traffic on the VLANs and thus potentially on other un-related data source points in the network. In this manner, implementing traffic flow control on such a prioritized VLAN flow control group provides for a superior degree of traffic control resolution when compared to prior art traffic control mechanisms.

The reason for this superior degree of traffic control resolution is that prioritized VLAN flow control groups each represent a set of traffic sub-flows within a switch, thereby allowing traffic flow control in accordance with the present invention to be implemented individually on each traffic sub-flow that is contributing to a particular instance of congestion.

In one embodiment of the present invention, a method for controlling traffic flow at a traffic routing device of a network comprises a plurality of operations. An operation is performed for determining an instance of traffic flow congestion for traffic of a particular VLAN (virtual local area network) flow control group and having a particular priority. The particular VLAN flow control group and the particular priority jointly define a particular prioritized VLAN flow control group. An operation is performed for issuing traffic flow instructions for causing flow of the traffic of the particular prioritized VLAN flow control group to be temporarily inhibited. Thereafter, an operation is performed for inhibiting transmission of traffic for the particular prioritized VLAN flow control group at a particular traffic routing device in response to the particular traffic routing device receiving the traffic flow instructions.

In another embodiment of the present invention, a traffic routing device for a network, comprises at least one data processing device, instructions processable by the at least one data processing device, and an apparatus from which the instructions are accessible by the at least one data processing device. The instructions are configured for causing the at least one data processing device to determine an instance of traffic flow congestion for traffic of a particular VLAN (virtual local area network) flow control group and having a particular priority. The particular VLAN flow control group and the particular priority jointly define a particular prioritized VLAN flow control group. The instructions are configured for causing the at least one data processing device to issue traffic flow instructions for causing flow of the traffic of the particular prioritized VLAN flow control group to be temporarily inhibited.

In another embodiment of the present invention, a computer-readable medium having tangibly embodied thereon and accessible therefrom a set of instructions interpretable by at least one data processing device. The set of instructions is configured for causing the at least one data processing device to carry out an operations for determining an instance of traffic flow congestion for traffic of a particular VLAN (virtual local area network) flow control group and having a particular priority. The particular VLAN flow control group and the particular priority jointly define a particular prioritized VLAN flow control group. The set of instructions is configured for causing the at least one data processing device to carry out an operations for issuing traffic flow instructions for causing flow of the traffic of the particular prioritized VLAN flow control group to be temporarily inhibited.

These and other objects, embodiments, advantages and/or distinctions of the present invention will become readily apparent upon further review of the following specification, associated drawings and appended claims.

### BRIEF DESCRIPTION OF THE DRAWINGS

FIG. 1A is a diagrammatic view showing an embodiment of congestion associated with per-port designated traffic in a network system.

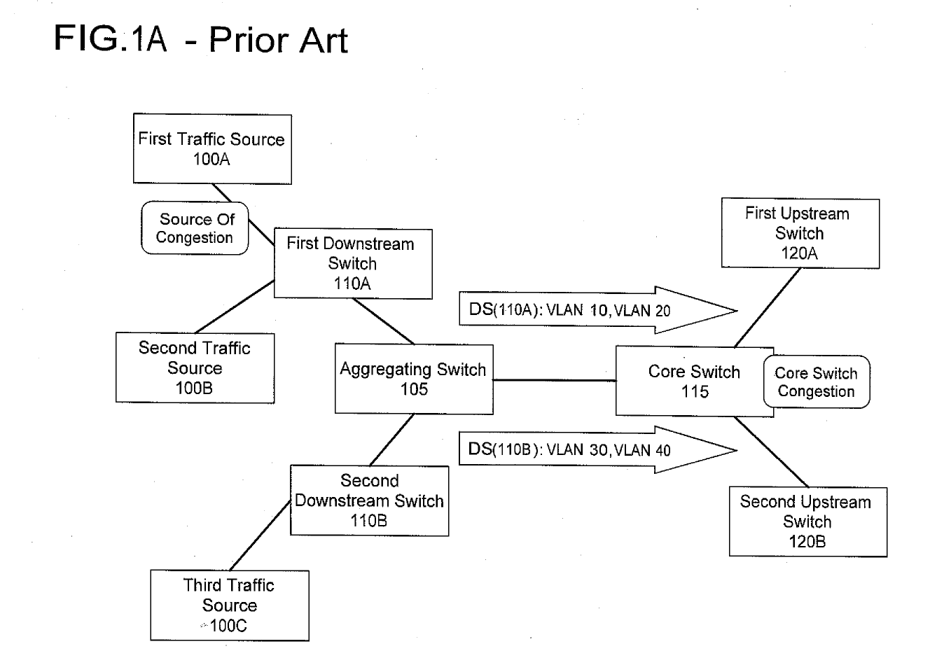

FIG. 1B is a diagrammatic view showing an embodiment of managing congestion in the network system of FIG. 1A using a prior art per-port flow control mechanism.

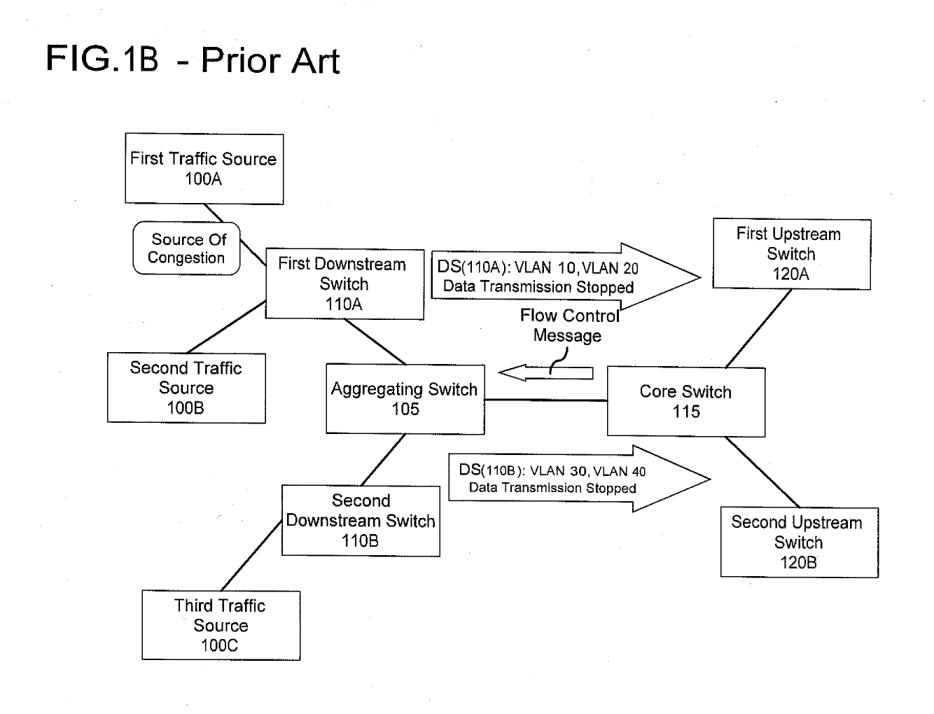

FIG. 2A is a diagrammatic view showing an embodiment of congestion associated with per-priority designated traffic in a network system.

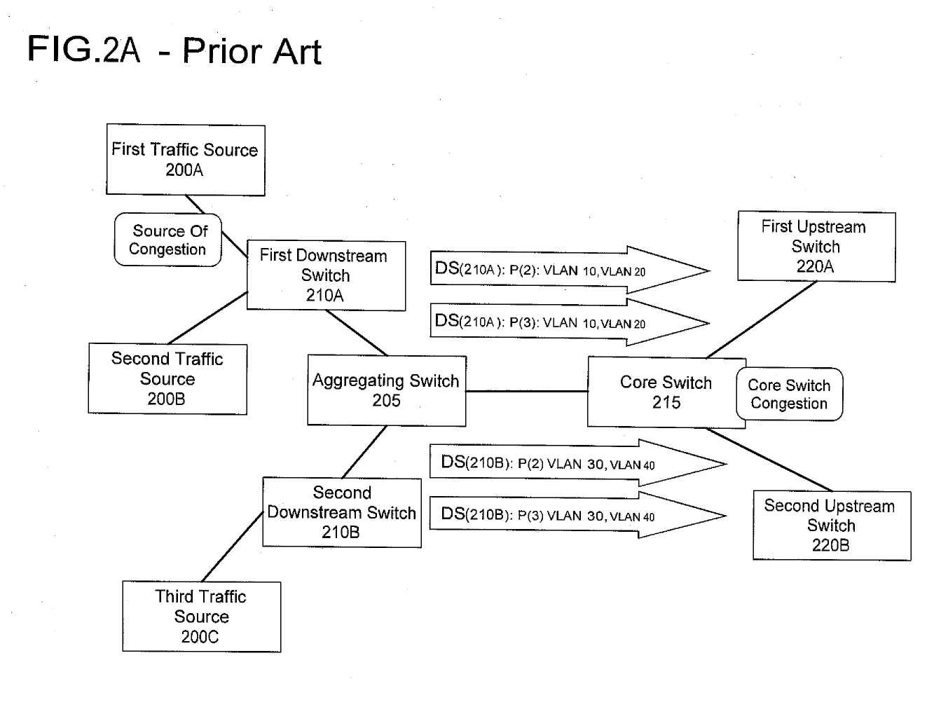

FIG. 2B is a diagrammatic view showing an embodiment of managing congestion in the network system of FIG. 2A using a prior art per-priority flow control mechanism.

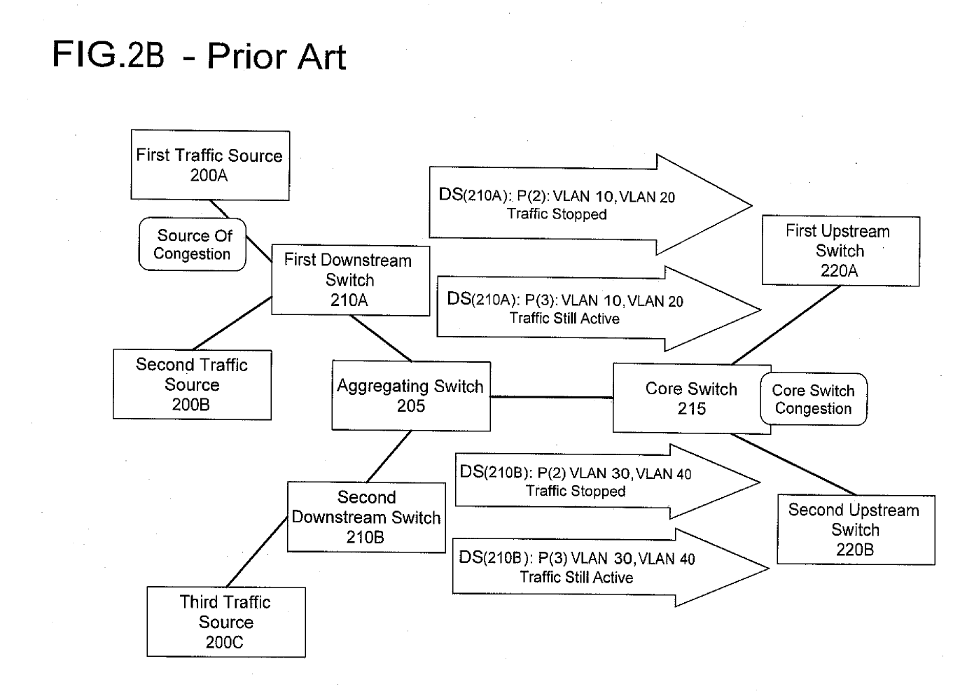

FIG. 3 is a diagrammatic view showing managing of congestion in the network system of FIG. 2A dependent upon a combination of VLAN flow control group and priority in accordance with an embodiment of the present invention.

### DETAILED DESCRIPTION OF THE DRAWING FIGURES

When congestion arises in a network system, it is desirable to mitigate adverse affect of such congestion without adversely impacting traffic that is not contributing to such congestion. To this end, flow control mechanisms configured in accordance with embodiments of the present invention provide for traffic flow control dependent upon a combination of VLAN (virtual local area network) group and priority. Unlike prior art implementations of traffic flow control, such flow control based on VLAN group and priority provides for the application of flow control on Ethernet packets belonging to a VLAN group and having a specific traffic priority assigned to it. Advantageously, in accordance with the present invention, the VLAN group can be a subset of VLANs of a link aggregation. This subset of VLANs of a link aggregation is created by logically partitioning the link aggregation (e.g., of a logical data pipeline between network routing devices). Such a subset of VLANs is referred to herein as a “VLAN flow control group” whereby traffic segregated on a per-priority basis within a per-VLAN flow control group is defined herein as a “prioritized VLAN flow control group”. It is disclosed herein that the number of minimum VLAN flow control group supported in the network can be primarily dependent on the minimum number of such bundles supported by any one of a plurality of switches in the network.

A switch is disclosed herein to be one example of a traffic routing device in a network. A bridge is another example of such a traffic routing device. From the disclosure made herein, a skilled person will appreciate that embodiments of the present invention are not unnecessarily limited as to their implementation into any particular type of configuration of traffic routing device.

VLAN links in aggregation and core switches often carry multiple aggregated flows in multiple VLANs. Furthermore, these types of switches typically maintain thresholds on the ingress stage of the packet-processing pipeline on a per-priority basis within a per-VLAN group. When a switch (e.g., core switch) configured in accordance with an embodiment of the present invention observes congestion (e.g., ingress buffers exceed the thresholds) for a particular VLAN Flow Control Group and priority pair (i.e., the particular prioritized VLAN flow control group), it issues a pause frame with appropriate back-off timer for only that particular prioritized VLAN flow control group. On receiving this pause control frame, a downstream device (e.g., aggregation switch) configured in accordance with an embodiment of the present invention asserts transmit disable state (e.g., XOFF state) for only the traffic stream belonging to that particular prioritized VLAN flow control group. So long as the congestion persists, the notifying switch (i.e., the switch that issued pause frame) keeps sending pause frames to keep transmission throttled for the culprit traffic flow (i.e., traffic flow corresponding to the particular prioritized VLAN flow control group). Once the congestion eases, the notifying switch issues a resume traffic frame (e.g., a pause frame with 0 pause duration) for the particular prioritized VLAN flow control group thereby causing flow of traffic for the particular prioritized VLAN flow control group to resume. The performance of VLANs that are not bundled into a distinct VLAN flow control group can preferably default to performance as currently supported in Ethernet switches. In contrast, data traffic bundled in VLAN flow control groups will exhibit more optimal lossless behavior.

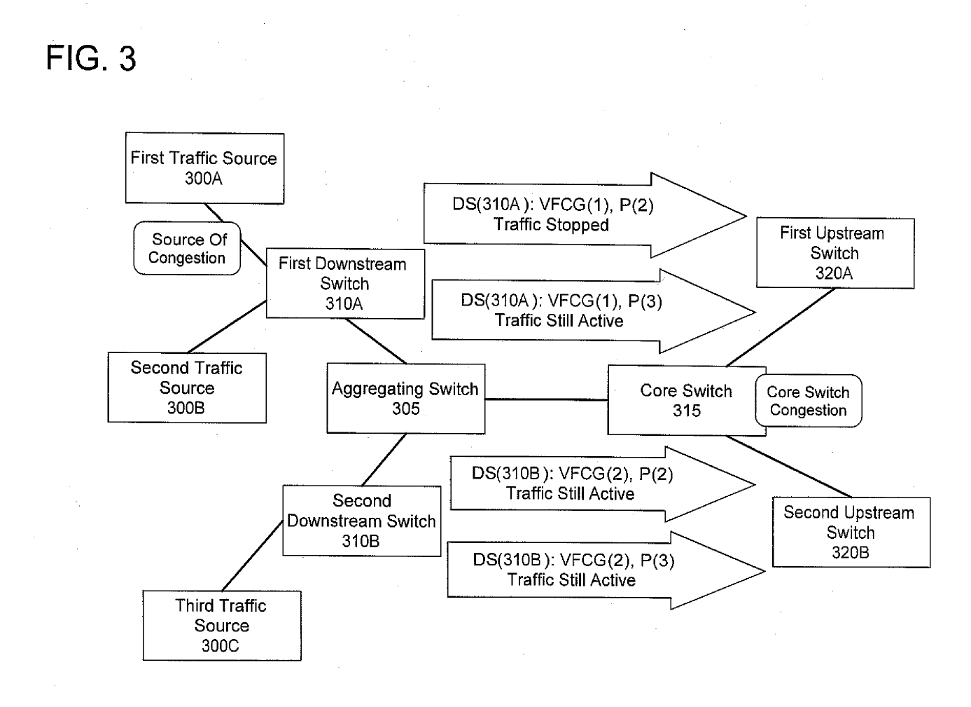

An embodiment of implementing traffic flow control on a per VLAN flow control group and per-priority basis in accordance with the present invention is shown in FIG. 3. A source of congestion (i.e., a first traffic source 300A) exists behind an aggregation switch 305 between a first downstream switch 230A and the first traffic source 300A. Traffic leading to such congestion (e.g., DS(310A): VFCG(1), P(2)) is routed via the first download switch 310A, is part of a first VLAN flow control group, and has a priority of 2, which represents the particular prioritized VLAN flow control group. Thus, the nomenclature associated with this particular prioritized VLAN flow control group and thus the congesting traffic is: DS(310A): VFCG(1), P(2).

It is disclosed herein that the particular VLAN flow control group can be a logically partitioned subset of VLANs of a pipeline defined by a link aggregation between the aggregation switch 305 and a core switch 315. It is also disclosed here in that the particular VLAN flow control group can consist of VLANs over which data from a single data source is carried. Examples of the single data source include, but are not limited to, a single server and a collection of servers serving data of common media content.

The result of the source of congestion is congestion at the core switch 315, which is connected to a plurality of upstream switches (e.g., first upstream switch 320A and second upstream switch 320B). Certain traffic that traverses the aggregation switch 305 toward the core switch 315 has the same priority as the offending traffic (e.g., traffic of priority (P2) from the second downstream switch 210B), but is of a different VLAN flow control group and is not contributing to such congestion. Similarly, certain other traffic that traverses the aggregation switch 305 toward the core switch 315 has a different priority as the offending traffic (e.g., traffic of priority (P3) from the first downstream switch 310A or the second downstream switch 310B) and is not contributing to such congestion regardless of its VLAN flow control group. Accordingly, because congestion is managed based on a combination of VLAN flow control group and priority, implementing traffic flow control in accordance with embodiments of the present invention provides for a superior degree of traffic control resolution when compared to prior art traffic control mechanisms, thereby enhancing lossless flow control functionality.

Still referring to FIG. 3, in response to a flow control message (e.g., pause frames on a particular port for Priority (P2)) being sent from the core switch 315 to the aggregation switch 205, the aggregation switch 205 throttles (i.e., inhibits) traffic for the particular prioritized VLAN flow control group. More specifically, traffic is throttled for traffic designated in FIG. 3 as DS(310A): VFCG(1), P(2), which is traffic of the particular prioritized VLAN flow control group. Advantageously, traffic of other prioritized VLAN flow control groups continues to be active even though some of that other traffic has the same priority as that of the particular prioritized VLAN flow control group or when such other traffic is of the same VLAN flow control group as the particular prioritized VLAN flow control group but is of a different priority. In accordance with the present invention, VLANs are assigned to different VLAN groups and they can carry traffic of any priority. To this end, a network element configured in accordance with the present invention tracks traffic for all priorities for the VLAN group. Furthermore, as indicated in the following examples, embodiments of the present invention do not impose the requirement for static mapping of a particular priority to a particular VLAN. For example, VLAN flow control group 1 (i.e., VFCG(1)) can include VLANs in the range of 10-20, with some of the VLANS in VLAN flow control group 1 having a priority of 2 (i.e., P(2)) and others having a priority of 3 (i.e., P(3)). Similarly, VLAN flow control group 2 (i.e., VFCG(2)) can include VLANs in the range of 30-40, with some of the VLANS in VLAN flow control group 2 having a priority of 2 (i.e., P(2)) and others having a priority of 3 (i.e., P(3)).

Turning now to further discussion on VLAN flow control groups, in order to support flow control mechanism with VLANs understanding the underlying switching, network hardware preferably maintains buffer accounting and thresholds in the ingress stage of the packet processing pipeline. Furthermore, in the egress stage of the pipeline, a processor such as an ASIC (application-specific integrated circuit) preferably provides either a per-flow queues or an accounting and transmit mechanism that is aware of the VLANs. Because core and aggregation switches can be carrying hundreds of VLANs, it has previously been challenging to support this type of flow control mechanism on a per-VLAN basis. To the contrary, implementing traffic flow control using VLAN flow control groups as disclosed herein provides a mechanism for configuring important sets of VLANs (i.e., sub-pipes) that originate from different network segments. These VLAN flow control groups can be monitored for flow control within a Ethernet network. Based on the capabilities of the underlying hardware of all the constituent traffic routing devices (e.g., switches) it is thereby possible to configure the minimum number of VLAN flow control groups for all the important data flows originating from different data sources within a core/aggregation portion of a network. It is also disclosed herein that there can also be one or more default VLAN flow control groups that manage all the set of VLANs that have not been assigned to a prioritized VLAN flow control group. In this manner, at least one VLAN flow control group will have a priority higher than the one or more default VLAN flow control groups

A traffic routing device configured in accordance with the present invention is aware of VLAN flow control groups and, preferably, maintains certain traffic flow information on a combined basis of VLAN flow control group and priority (e.g., for each prioritized VLAN flow control group). Such awareness and monitoring is useful in supporting lossless operation through the use of VLAN flow control groups that are configured in accordance with the present invention. One example of such traffic flow information includes thresholds in the ingress pipeline defining separate thresholds for all prioritized VLAN flow control groups. Another example of such traffic flow information includes accounting statistics for buffer consumption in the ingress pipeline on a per prioritized VLAN flow control group basis. Still another example of such traffic flow information includes flow based egress queues and/or support of control of transmission on the basis of VLAN flow control group.

Discussed now is a mechanism for the propagation and handling of VLAN flow control group information across a network. Such a mechanism preferably propagates the VLAN flow control group information across network elements in an Ethernet network so that all constituent network devices (i.e., traffic routing devices) are aware of the VLAN flow control groups and are accordingly able to setup their resources for performing traffic flow control using VLAN based flow control in accordance with the present invention. In the case of data center networks, DCBX (Data Center Bridging Exchange) is a preferred management protocol used for propagation of the device capability information across network elements. DCBX is an extension of Link Layer Discovery Protocol (LLDP) that is used for discovering the capability of the devices (e.g., network elements) across network links and checking consistency of their capabilities.

In accordance with one embodiment of the present invention, all devices of a network that are capable of supporting traffic flow control using prioritized VLAN flow control group as disclosed herein negotiate the number and range of VLANs in each VLAN flow control group. It is disclosed herein that supplemental (e.g., newly-implemented) extensions can be used for adding VLAN flow control group information in the LLDP TLV (type-length-value). Accordingly, through the addition of such supplemental extensions the VLAN flow control group information can be transmit in the network.

There are two processing components of this solution. A first one of these components is responsible for generation and processing of the pause frames. In one embodiment, this first component needs to be implemented in a data path ASIC (i.e., application specific integrated circuit) or as micro-code of a network processor (e.g., such as that of a network element). A second one of these components is a software component that is responsible for negotiation of one or more VLAN flow control groups and, optionally, for configuration of the information in the data path components such as the ASIC. Examples of such information include, but are not limited to, list of VLANs belonging to each VLAN flow control group, buffer thresholds on a per “VLAN flow control basis” and priority basis which when exceeded would trigger a flow control message to the downstream device.

Referring now to instructions processible by a data processing device, it will be understood from the disclosures made herein that methods, processes and/or operations adapted for carrying out traffic flow control functionality on a prioritized VLAN flow control group basis as disclosed herein are tangibly embodied by computer readable medium (e.g., a non-transient computer readable medium) having instructions thereon that are configured for participating in the implementation of such functionality. In one specific embodiment, the instructions are tangibly embodied for carrying out respective portions of traffic flow control functionality on a prioritized VLAN flow control group basis as discussed above in reference to FIG. 3. For example, such instructions can be embodied as a instructions configured for negotiation of one or more VLAN flow control groups and for configuration of the information in the data path components. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the presenting invention include a compact disk, a hard drive, RAM or other type of storage apparatus that has imaged thereon a computer program (i.e., instructions) adapted for carrying out traffic flow control functionality on a prioritized VLAN flow control group basis.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method for controlling traffic flow at a traffic routing device of a network, comprising:
at least one data processing device accessing, from memory coupled to said at least one data processing device, instructions causing said at least one data processing device to determine an instance of traffic flow congestion for traffic of a particular VLAN (virtual local area network) flow control group and having a particular priority, wherein the particular VLAN flow control group and the particular priority jointly define a particular prioritized VLAN flow control group;
said at least one data processing device accessing, from said memory, instructions causing said at least one data processing device to issue traffic flow instructions for causing flow of said traffic of the particular prioritized VLAN flow control group to be temporarily inhibited; and
said at least one data processing device accessing, from said memory, instructions causing said at least one data processing device to inhibit transmission of traffic for the particular prioritized VLAN flow control group at a particular traffic routing device in response to the particular traffic routing device receiving said traffic flow instructions.

2. The method of claim 1 wherein the particular VLAN flow control group is a logically partitioned subset of VLANs of a pipeline defined by a link aggregation.

3. The method of claim 2 wherein the particular VLAN flow control group consists of VLANs over which data from a single data source is carried.

4. The method of claim 1 wherein the particular VLAN flow control group consists of VLANs over which data from a single data source is carried.

5. The method of claim 1, further comprising:
said at least one data processing device accessing, from said memory, instructions causing said at least one data processing device to maintain traffic flow information on a combined basis of VLAN flow control group and priority.

6. The method of claim 5 wherein said traffic flow information includes:
an ingress pipeline threshold for the particular prioritized VLAN flow control group;
buffer consumption statistics for an ingress pipeline of the particular prioritized VLAN flow control group; and
at least one of flow based egress queues and support of control of transmit for the particular VLAN flow control group.

7. The method of claim 5, further comprising:
said at least one data processing device accessing, from said memory, instructions causing said at least one data processing device to inhibit transmission of traffic for the particular prioritized VLAN flow control group at a particular traffic routing device in response to the particular traffic routing device receiving said traffic flow instructions.

8. The method of claim 7 wherein:
the particular VLAN flow control group consists of VLANs over which data from a single data source is carried; and
the particular VLAN flow control group is a logically partitioned subset of VLANs of a pipeline defined by a link aggregation.

9. A traffic routing device for a network, comprising:
at least one data processing device;
instructions processable by said at least one data processing device; and
an apparatus from which said instructions are accessible by said at least one data processing device;
wherein said instructions are configured for causing said at least one data processing device to:
determine an instance of traffic flow congestion for traffic of a particular VLAN (virtual local area network) flow control group and having a particular priority, wherein the particular VLAN flow control group and the particular priority jointly define a particular prioritized VLAN flow control group; and
issue traffic flow instructions for causing flow of said traffic of the particular prioritized VLAN flow control group to be temporarily inhibited.

10. The traffic routing device of claim 9 wherein said instructions are further configured for causing said at least one data processing device to:
inhibit transmission of traffic for the particular prioritized VLAN flow control group at a particular traffic routing device in response to the particular traffic routing device receiving said traffic flow instructions.

11. The traffic routing device of claim 9 wherein the particular VLAN flow control group is a logically partitioned subset of VLANs of a pipeline defined by a link aggregation.

12. The traffic routing device of claim 11 wherein the particular VLAN flow control group consists of VLANs over which data from a single data source is carried.

13. The traffic routing device of claim 12 wherein said instructions are further configured for causing said at least one data processing device to maintain traffic flow information on a combined basis of VLAN flow control group and priority.

14. The traffic routing device of claim 13 wherein said instructions are further configured for causing said at least one data processing device to inhibit transmission of traffic for the particular prioritized VLAN flow control group at a particular traffic routing device in response to the particular traffic routing device receiving said traffic flow instructions.

15. A computer-readable medium having tangibly embodied thereon and accessible therefrom a set of instructions interpretable by at least one data processing device, said set of instructions configured for causing said at least one data processing device to carry out operations for:
determining an instance of traffic flow congestion for traffic of a particular VLAN (virtual local area network) flow control group and having a particular priority, wherein the particular VLAN flow control group and the particular priority jointly define a particular prioritized VLAN flow control group; and
issuing traffic flow instructions for causing flow of said traffic of the particular prioritized VLAN flow control group to be temporarily inhibited.

16. The computer-readable medium of claim 15 wherein said set of instructions are further configured for causing said at least one data processing device to carry out operations for:
inhibiting transmission of traffic for the particular prioritized VLAN flow control group at a particular traffic routing device in response to the particular traffic routing device receiving said traffic flow instructions.

17. The computer-readable medium of claim 15 wherein the particular VLAN flow control group is a logically partitioned subset of VLANs of a pipeline defined by a link aggregation.

18. The computer-readable medium of claim 17 wherein the particular VLAN flow control group consists of VLANs over which data from a single data source is carried.

19. The computer-readable medium of claim 18 wherein said set of instructions are further configured for causing said at least one data processing device to carry out operations for:
maintaining traffic flow information on a combined basis of VLAN flow control group and priority.

20. The computer-readable medium of claim 19 wherein said set of instructions are further configured for causing said at least one data processing device to carry out operations for:
inhibit transmission of traffic for the particular prioritized VLAN flow control group at a particular traffic routing device in response to the particular traffic routing device receiving said traffic flow instructions.
